(19) United States
(12) Patent Application Publication
(10) Pub. No.: US 2012/0185916 A1
(43) Pub. Date: Jul. 19, 2012

(54) APPARATUS AND METHOD FOR STATISICAL USER AUTHENTICATION USING INCREMENTAL USER BEHAVIOR

(76) Inventors: Seung-Chul CHAE, Seoul (KR); Sun-Jae LEE, Suwon-Si (KR)

(21) Appl. No.: 13/170,818

(22) Filed: Jun. 28, 2011

(30) Foreign Application Priority Data
Jan. 14, 2011 (KR) 10-2011-0004262

(51) Int. Cl. G06F 7/04

(52) U.S. Cl. 726/2

(57) ABSTRACT

Provided are an apparatus and method for statistical user identification that improves a user's convenience while ensuring security. The apparatus may store a confidence value that statistically represents whether a user is identified as a user that has permission to use a terminal, based on a user event that occurs when the user manipulates the terminal. The apparatus may determine whether to execute a user requested application by comparing the confidence value of the user with a reference value that is defined for the requested application.

### CROSS-REFERENCE TO RELATED APPLICATION(S)

This application claims the benefit under 35 U.S.C. §119(a) of Korean Patent Application No. 10-2011-0004262, filed on Jan. 14, 2011, in the Korean Intellectual Property Office, the entire disclosure of which is incorporated herein by reference for all purposes.

### BACKGROUND

1. Field

The following description relates to a user authentication technology.

2. Description of the Related Art

As the use of electronic devices increases and the development of Internet and web based network technology becomes more active, there is an increasing need for user authentication that can be performed online or offline.

In particular, if an electronic device such as a smart phone is used by another user other than the owner of the electronic device, the owner may have valuable information stolen or otherwise made more vulnerable. In addition, there is concern for stored private information being exposed, such as contact information and financial information.

In order to provide security there is a popular method for electronic user identification using an ID (identifier) and a password. In an online environment, the electronic user identification may be achieved by use of a unique identifier (ID) that identifies a user in an electrical manner and a password that proves the identity of the user.

Such an ID/password based authentication is easy to use and is wide spread, but such an easy to use authentication method involves various types of security issues. For example, some passwords may easily be guessed by others, so the user may be easily impersonated by others. Conversely, complicated passwords may not easily be guessed but at the same time they may not be easy for the owner to remember.

In order to avoid the above shortcomings, various user identification methods including Biometric authentication, such as fingerprint identification, and one-time password have been suggested. However, these techniques can be more expensive and cumbersome to employ.

Another shortcoming associated with these described authentication methods is that once granted permission a user may use resources of a device without any restriction. Accordingly, if the device is exposed to viruses even once or if a user is not in complete control of the device while in a state of log-in, unexpected damages may be caused.

### SUMMARY

In one general aspect, there is provided an apparatus for statistical user identification, the apparatus including an update unit configured to update a confidence value that statistically represents whether a user is identified as being a user that has permission to use a terminal, based on a user event that occurs when the user manipulates the terminal, and a statistical authentication unit configured to, in response to a user requesting execution of an application that requests authentication, determine whether to execute the requested application by comparing the confidence value with a reference value that is defined for the requested application.

The apparatus may further comprise a storage unit configured to store the confidence value, a user model that is generated based on feature information about a manipulation pattern that is obtained when the user manipulates the terminal, and a reference value defined for each application.

The update unit may update the confidence value by increasing or decreasing the confidence value based on the comparison between the user event and the user model.

The update unit may decrease the confidence value if a user event is not detected within a predetermined period of time.

The update unit may apply feature information of a user event that occurs after the updated confidence value exceeds a predetermined threshold value, to the user model.

The statistical authentication unit may accept the execution of the application, if the confidence value exceeds the reference value.

The statistical authentication unit may deny the execution of the application, if the confidence value is below the reference value.

The statistical authentication unit may demand additional authentication from the user, if the confidence value is below the reference value.

The statistical authentication unit may calculate a difference between the confidence value and the reference value, if the confidence value is below the reference value, and may demand additional authentications from the user based on the calculated difference.

In one general aspect, there is provided a method of statistical user identification, the method including updating a confidence value that statistically represents whether a user is identified as being a user that has permission to use a terminal, based on a user event that occurs when the user manipulates the terminal, and upon occurrence of a user event requesting execution of an application that requests authentication, determining whether to execute the requested application by comparing the confidence value with a reference value that is defined for the requested application.

The updating may comprise updating the confidence value by increasing or decreasing the confidence value based on a comparison between the user event and the user model.

The updating may comprise decreasing the confidence value, if a user event is not detected within a predetermined period of time.

The method may further comprise applying feature information of a user event that occurs after the updated confidence value exceeds a predetermined threshold value, to the user model.

The determining of execution of the application may comprise executing the application, if the confidence value exceeds the reference value.

The determining of execution of the application may comprise not executing the application, if the confidence value is below the reference value.

The determining of execution of the application may comprise requesting an additional authentication of the user, if the confidence value is below the reference value.

In another aspect, there is provided a method for statistical user identification, the method including detecting a user event that occurs when a user manipulates a terminal, comparing feature information of the detected user event with feature event of a user model and updating a confidence value that statistically represents whether a user has permission to use the terminal, based on a comparison result of the feature information, determining whether the detected user event is a user event requesting execution of an application which is executable in the terminal and which requests authentication, and determining whether to execute the application by comparing the updated confidence value with a reference value that is a previously defined for each application, if the detected user event is the user event requesting execution of the application.

The method may further comprise generating an initial user model based on feature information about a manipulation pattern that is obtained when the user manipulates the terminal, and generating an initial confidence value that statistically represents whether a user has permission to use the terminal.

In another aspect, there is provided a terminal for statistical identification of a user that manipulates the terminal, the terminal including a storage unit configured to store a confidence value that statistically represents whether the user has permission to use a respective application, and a statistical authentication unit configured to determine whether the user has permission to execute a requested application by comparing the user's confidence value with a reference value that is defined for the requested application.

The user's confidence value may be N, a first application requested by the user may have a reference value that is greater than N, and the statistical authentication unit may determine to deny execution of the application based on a comparison of the user's confidence value and the reference value.

A second application requested by the user may have a reference value that is less than N, and the statistical authentication unit may determine to execute the application based on a comparison of the user's confidence value and the reference value.

The confidence value may be a number between 0% and 100%, wherein 0% represents the minimum confidence value the terminal can have for the user, and 100% represents the maximum confidence value that the terminal can have for the user.

The terminal may further comprise one or more sensors configured to sense user manipulation of the terminal, and an update unit configured to update the confidence value of the user based on the sensed user's manipulation of the terminal.

The one or more sensors may sense at least one of pressure applied by the user to a touch screen of the terminal and speed at which the user inputs characters on the touch screen of the terminal, and the update unit may update the confidence value based on the sensed data.

Other features and aspects may be apparent from the following detailed description, the drawings, and the claims.

### BRIEF DESCRIPTION OF THE DRAWINGS

FIG. 1 is a diagram illustrating an example of an apparatus for user identification.

FIG. 2 is a diagram illustrating an example of information that is stored in a storage unit.

FIGS. 3A to 3F are diagrams illustrating examples of a tutorial mode for generating a user model.

FIG. 4 is a diagram illustrating an example of Statistical Access Control List (SACL).

FIG. 5 is a diagram illustrating an example of an update unit.

FIG. 6 is a diagram illustrating an example of a statistical authentication unit.

FIG. 7 is a diagram illustrating an example of a method for user identification.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

In various examples herein, an apparatus and a method for statistical user identification may be applied to a terminal to perform authentication. For example, the terminal may be a computer, a mobile terminal, a smart phone, a laptop computer, a personal digital assistant, a tablet, an MP3 player, a home appliance, a television, and the like.

In various aspects described herein, it is possible to statistically judge whether a current user has permission to use a terminal other than a decisive Yes or No judgment, and it is possible to determine whether to execute an application that requests authentication based on the judgment result.

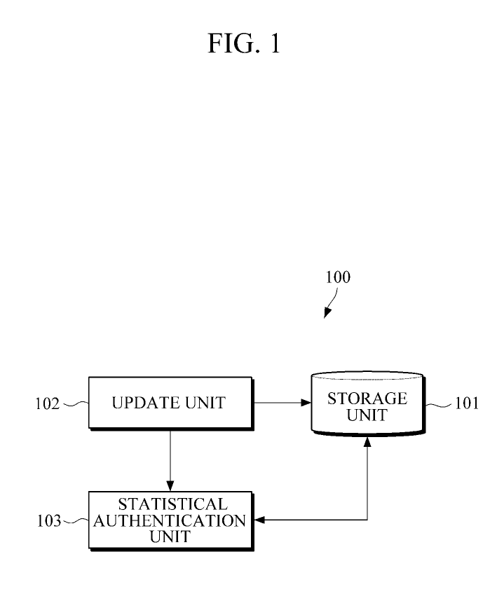

FIG. 1 illustrates an example of an apparatus for user identification.

Referring to FIG. 1, apparatus 100 for user identification includes a storage unit 101, an update unit 102, and a statistical authentication unit 103.

The storage unit 101 may store data, for example, a confidence value, a reference value, and a user model.

The confidence value is a value which may be used to statistically represent whether a user is identified as a user that has permission to use a terminal. For example, the confidence value may range between 0% to 100%. The confidence value may be continually updated. For example, a current confidence value of 50% at present may be updated to be above 50% or below 50% based on a particular situation. An initial confidence value may be set to 0%. As another example, the initial confidence value may be set between 0% and 50%.

The reference value may be set to a different value for each application that request authentication, and corresponds to the confidence value. For example, an application for settling a transaction electronically in a smart phone may desire a high level of user identification. Accordingly, the reference value of the application may be set to a high level, for example, 100% or nearly 100%. An application for changing the background image may not use a high level of privacy protection, and the reference value of the application for changing the background image may be set to a low level.

Whether to execute an application that requests authentication may be determined based on a comparison of the reference value, which is assigned for each application, and the current confidence value. For example, if the current confidence value is below the reference value, execution of the application having the corresponding reference value may be denied. As another example, if the current confidence value exceeds the reference value, execution of the application having the corresponding reference value may be accepted.

For example, if the current confidence value is 70%, execution of the application of electronic settlement having a reference value of 100% may be denied. However, if the application for changing a background image change is only 30%, execution of the application for background image change may be accepted.

As described in various examples, the reference value of each application may be set to a different value based on the characteristic of each application. For example, the reference value of an application closely related to privacy protection may be set high. In addition, each user may feel the invasion of privacy to a different degree when the same application is executed. Accordingly, the reference value of an application may be changed by a user based on the tendency of the user in use of the application.

The user model includes feature information about a manipulation pattern that is obtained based on the user manipulating a terminal. The user model corresponds to user tendency information about how a user manipulates a terminal while using the terminal. With the use of the terminal, the user model may be continually updated, so that the tendency of the user may be applied to the user model.

In the example of a smart phone, feature information about a manipulation pattern may represent the pressure applied when a user touches the terminal, the time interval when each character of a word sequence is input, the distance between the terminal and ear of a user when the user makes a phone call, and the like. It should be appreciated that the feature information about the manipulation pattern is not limited thereto and may be provided in various forms. An initial user model may be generated by use of feature information that may be input through a tutorial mode that starts at the first execution of a newly purchased terminal.

The update unit 102 may continually update the confidence value that is stored in the storage unit 101, based on the user event. In this example, the user event represents a result that occurs as the user manipulates the terminal.

For example, the update unit 102 may decrease the confidence value that is stored in the storage unit 101, if the user event does not occur within a predetermined period of time. For example, if the user does not use the terminal for a long period of time, the confidence value may be decreased.

If a user event occurs within a predetermined period of time, the update unit 102 may compare the user event with the user model that is stored in the storage unit 101. If the user event is similar to the user model, the update unit 102 may increase the confidence value that is stored in the storage unit 101. If the user event is not similar to the user model, the update unit 102 may decrease the confidence value that is stored in the storage unit 101.

The similarity between the user event and the user model may be acquired through the similarity between the feature information included in the user event and the feature information included in the user model. For example, when the user pushes a button may be feature information. If a user pushes a button of a newly purchased terminal to perform an initial setting, the pressure that is applied while the user pushes the button may be stored as the user model. After the user model is generated, if the user pushes a button for a predetermined function of the terminal, the update unit 102 may compare the pressure of the user model with the pressure that is applied when the user pushes the button for a predetermined function. If the difference in pressure falls within a predetermined threshold range, the update unit 102 may increase the confidence value, and if the difference is outside the predetermined threshold range, the update unit 102 may decrease the confidence value.

As described herein, the update unit 102 may update the user model that is stored in the storage unit 101. For example, if the confidence value that is continually updated exceeds a predetermined threshold value, the update unit 102 may apply a user event that occurs after the confidence value exceeds the predetermined threshold value, to the user model, thereby updating the user model.

Upon the occurrence of a user event, the statistical authentication unit 103 may determine whether the user event is a user event that requests execution of an application which requests authentication. If the user event requests execution of an application that requests authentication, the statistical authentication unit 103 may determine whether to execute the application by comparing the confidence value stored in the storage unit 101 with the reference value that is defined for each application.

For example, the statistical authentication unit 103 may accept the execution of the application if the confidence value exceeds the reference value. As another example, the statistical authentication unit 103 may deny the execution of the application if the confidence value is below the reference value, and in some examples, may demand an additional authentication from the user. The additional authentication may be provided in various forms. The statistical authentication unit 103 may calculate the difference between the confidence value and the reference value, and may demand an additional authentication based on the calculated difference.

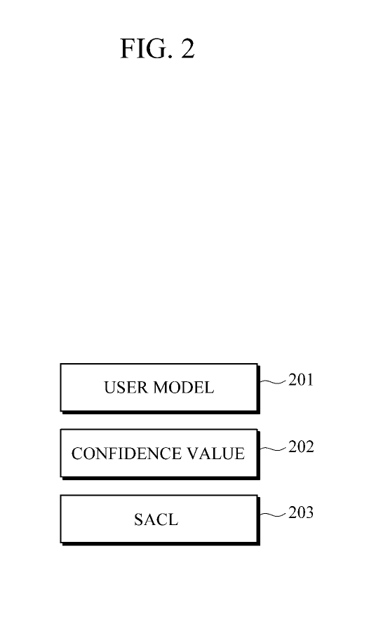

FIG. 2 illustrates an example of information that is stored in a storage unit.

Referring to FIGS. 1 and 2, the storage unit 101 may store a user model 201, a confidence value 202, and a Statistical Access Control List (SACL) 203.

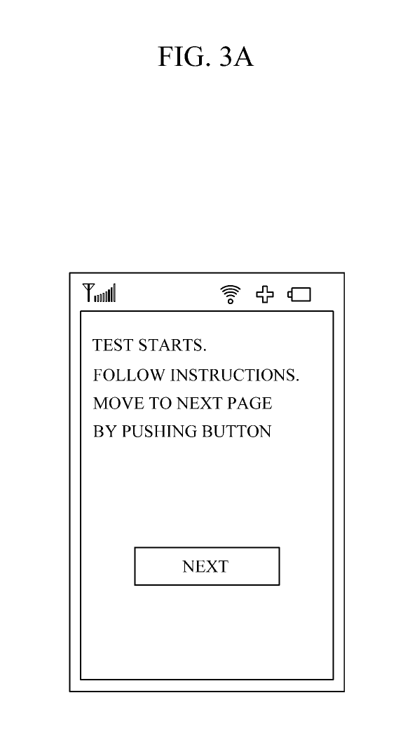

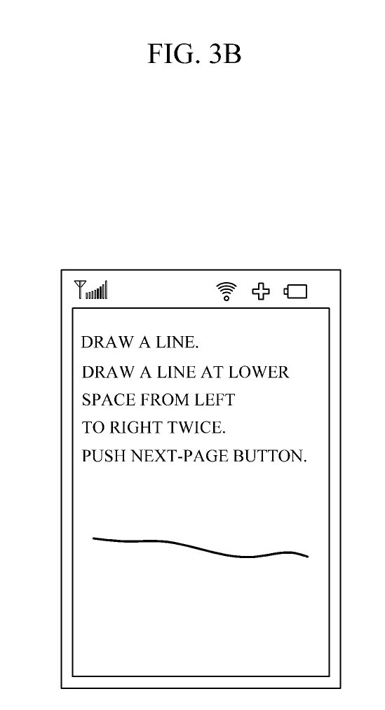

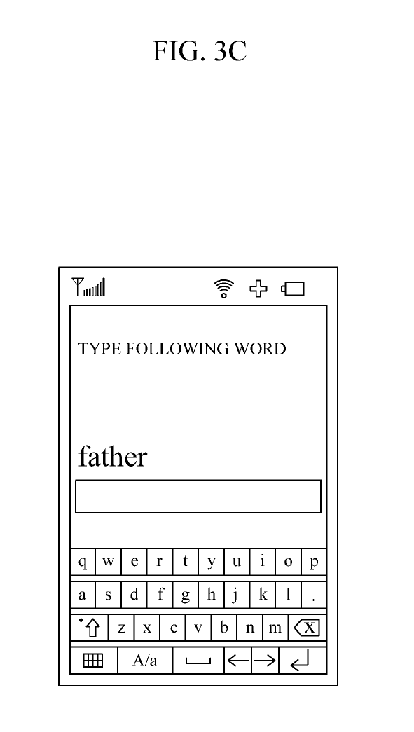

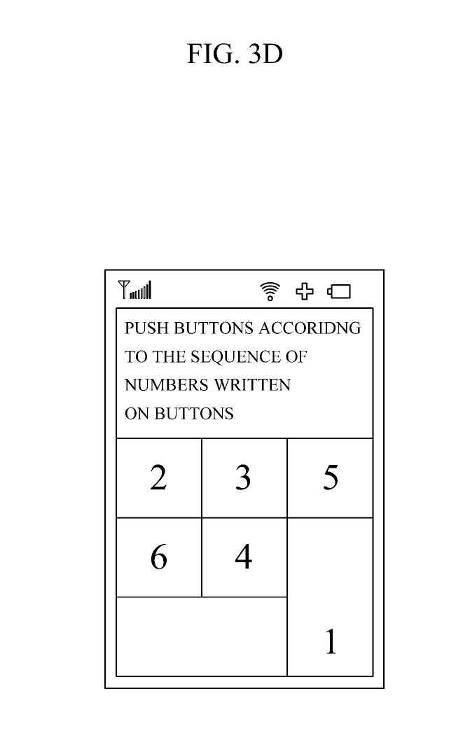

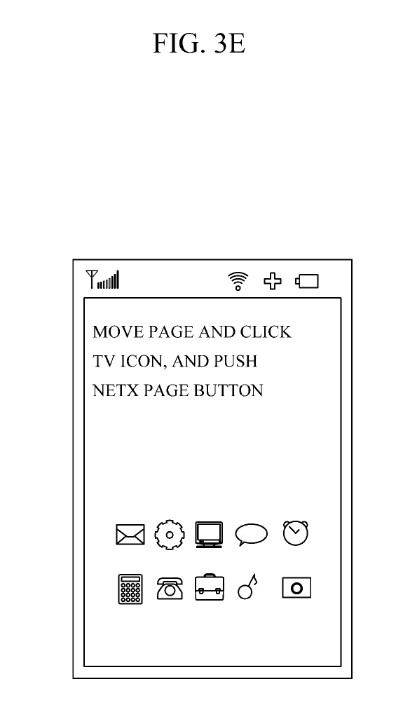

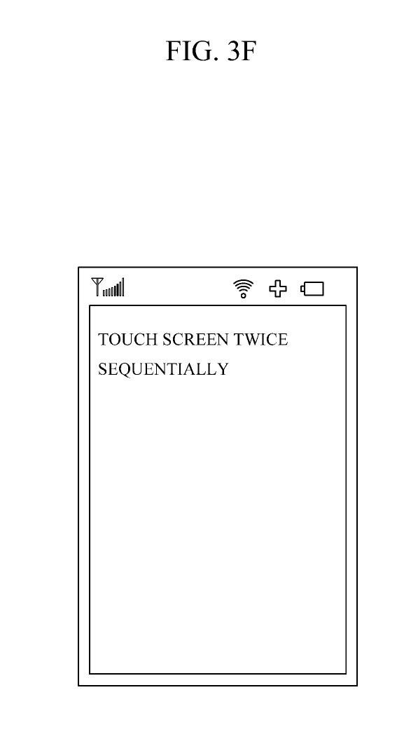

The user model 201 may represent a user behavior pattern model that is generated based on feature information about a manipulation pattern that is obtained when the user manipulates the terminal to use a predetermined function of the terminal. The user model 201 may be initially generated through the tutorial mode of the terminal (see FIG. 3) and may be continually updated after the generation.

The confidence value 202 is a value that may be used to statistically represent whether a user is identified as being a user that has permission to use a terminal. For example, the confidence value 202 may be set to a value between 0% to 100%.

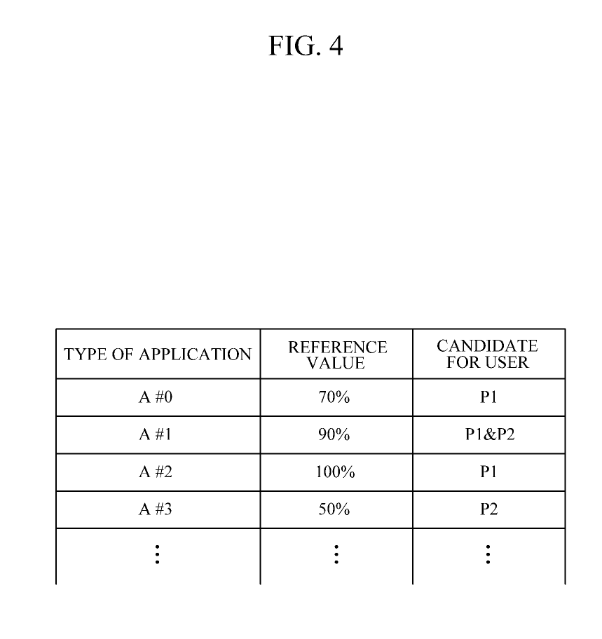

The SACL 203 represents a Statistical Access Control List. A reference value for each application, which corresponds to the confidence value 202, may be mapped in the SACL 203 (see FIG. 4). Whether to execute each application may be determined based on a comparison between the confidence value 202 and the reference value.

FIGS. 3A to 3F illustrate examples of a tutorial mode for generating a user model.

Referring to FIGS. 3A to 3F, a user, that is, a purchaser of a terminal, may take on a predetermined behavior according to an instruction of the terminal to use a statistical authentication function. The terminal may extract feature information about the behavior and may generate an initial user model based on the extracted feature information.

In FIG. 3A, the terminal displays a notice message indicating a start of a predetermined test according to a tutorial mode. For example, the user may enter a detailed setting stage by manipulating a touch screen of the terminal according to the guideline message.

In FIG. 3B, the terminal displays a curved line and a notice message instructing the user to perform a drawing motion along the curved line. In response to the user drawing the curved line through a manipulation of touching the screen of the terminal, the terminal may extract the time and/or speed that is obtained when a finger of the user moves from the left end to right end, or vice-versa, as feature information of the user model. As another example the terminal may extract the pressure obtained when the user pushes the screen along the curved line, as the feature information of the user model.

In FIG. 3C, the terminal displays a predetermined word on the screen and a notice message instructing the user to input the word. In response to the user inputting the word through a manipulation of the terminal, the terminal may extract the pressure that is obtained when the user pushes the screen to input a single character, and the time interval obtained between button pushes of serial characters, as the feature information of the user model.

In FIG. 3D, the terminal displays serial numbers on the screen of the terminal and a notice message instructing the user to push the serial numbers on the display in the order of the serial numbers 1-6. In response to the user pushing the serial numbers in the display order by touching the screen of the terminal, the terminal may extract the angle at which the user holds the terminal, and the time interval obtained between button pushes for the serial numbers, as the feature information of the user model.

In FIG. 3E, the terminal displays a plurality of icons on the screen of the terminal and a notice message instructing the user to select a predetermined icon from among the icons. In response to the user selecting a predetermined icon by touching the screen of the terminal, the terminal may extract the type of a behavior of the user which is obtained when the user touches or drags the icon, as the feature information of the user model.

In FIG. 3F, the terminal displays a notice message instructing the user to touch the screen twice. In response to the user touching the screen of the terminal twice, the terminal may extract the interval between touches, the touch position, the touch pressure, and the time taken by the completion of the touch after the display of the notice message, as the feature information of the user model.

The examples of FIGS. 3A through 3F are merely for purposes of example of collecting the type of behavior while a user manipulates a terminal, and the method of collecting feature information and generating the user model may be implemented in various forms.

Also, a method of setting an initial user model is not limited to using a tutorial mode. For example, a predetermined user model may be set as an initial model without using a tutorial mode, and the user mode may be updated based on the user that uses the terminal.

FIG. 4 illustrates an example of Statistical Access Control List (SACL).

Referring to FIG. 4, the SACL includes the type of each application, the reference value of each application, and the candidate for a user who has a possibility of accessing each application. The reference value and the candidate for a user may be previously set. As another example, if a predetermined application is installed on a terminal, related information may be received from a third party corresponding to the sender of the application, and may be added to the SACL. As another example, the SACL may have a value that is fixed by a developer of the application or a value that is adjustable within a predetermined range by a user that gains a predetermined permission to access the SACL. For example, the predetermined permission may be gained if an additional authentication process such as biometric authentication is passed or the confidence value reaches a level of 100%.

In FIG. 4, the terminal using the SACL compares the current confidence value with the reference value of an application that is requested for execution, to determine whether to execute the application.

For example, if the current confidence value has a level of 80%, and a user P1 requests execution of an application A#0, the application A#0 may be executed at the request without an additional authentication process. As another example, if a user P1 makes a request for execution of an application A#1, the application A#1 may be denied execution and/or the application may demand an additional authentication process.

In various aspects, the SACL may be formed for each candidate for a user. That is, different from the SACL shown FIG. 4 in which the reference of the application A#1 is assigned with a level of 90% to both of the user candidate P1 and the user candidate P2, a SACL may be formed such that different reference values of an application are assigned to different user candidates, for example, the reference value of the application A#1 may be assigned with 100% to the user candidate P1 and with 80% to the user candidate P2.

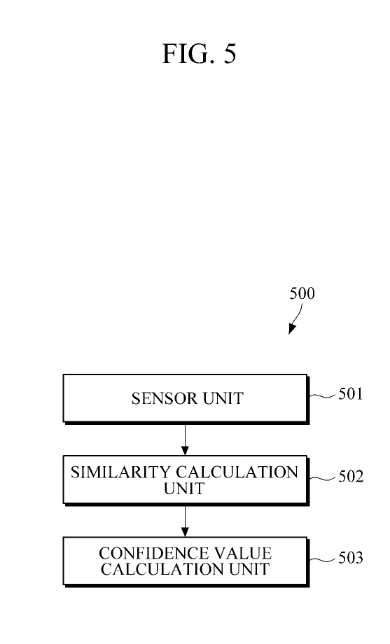

FIG. 5 illustrates an example of an update unit.

Referring to FIG. 5, update unit 500 continually updates a confidence value that is used to statistically represent whether a user of a terminal has permission to use the terminal, based on a user event that occurs when the user manipulates the terminal. The update unit 500 includes a sensor unit 501, a similarity calculation unit 502, and a confidence value calculation unit 503.

The sensor unit 501 may detect various feature information included in a user event. The user event may include the events that occur while the user manipulates the terminal. For example, if a user strokes a predetermined part of the screen of the terminal to lock the terminal to a hold state or unlock the hold state, the sensor unit 501 may detect the manipulation pattern, for example, the pressure applied to stroke the screen and the direction of motion of the finger.

For example, the sensor unit 501 may include a physical sensor such as an accelerometer, and/or a logical sensor such as a timer. For example, the sensor unit 501 may include a pressure sensor, a gyro sensor, an acoustic sensor, an accelerometer, and a timer. In addition, the sensor unit 501 may further include a signal processing module to extract a desired signal from data that is detected from each sensor.

The similarity calculation unit 502 may compare the feature information of the user event detected by the sensor unit 501 with the feature information of the user model to calculate the similarity between the user event and the user model. For example, the similarity calculation unit 502 may calculate the similarity through the following equation.

Cn=Fn(Sn,M) [Equation 1]

In Equation 1, Cn is the similarity, Fn is a comparison function, Sn is a user event or feature information of a user event, and M is a user model or feature information of a user model.

The confidence value calculation unit 503 may increase or decrease the confidence value based on the calculated similarity that is obtained from the similarity calculation unit 502. For example, the confidence value calculation unit 503 may increase the stored confidence value if the calculated similarity exceeds a predetermined threshold value, and may decrease the stored confidence value if the calculated similarity is below a predetermined threshold value.

As another example, the confidence value calculation unit 503 may decrease the confidence value if the confidence value calculation unit 503 does not receive a detection result or a calculation result from the sensor unit 501 and/or the similarity calculation unit 502 within a predetermined period of time.

As another example, if the confidence value increases beyond a predetermined threshold value, the confidence value calculation unit 503 may apply feature information of a user event that is received after the confidence value increases beyond the predetermined threshold value, to the user model, thereby updating the user model.

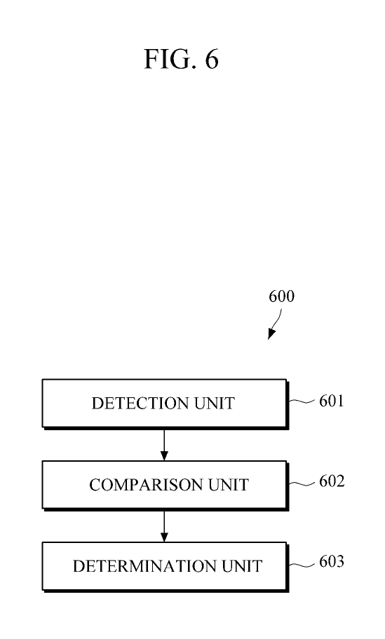

FIG. 6 illustrates an example of a statistical authentication unit.

Referring to FIG. 6, upon a user event requesting execution of an application that requests authentication, a statistical authentication unit 600 may determine whether to execute the requested application by comparing the confidence value with a reference value that is defined for the application. In this example, the statistical authentication unit 600 includes a detection unit 601, a comparison unit 602 and a determination unit 603.

The detection unit 601 may detect a user event that requests execution of an application from among a plurality of user events. In addition, the detection unit 601 may determine whether the corresponding application requests authentication.

At the request for execution of an application requesting authentication, the comparison unit 602 may compare the current confidence value with the reference value of the application. The current confidence value may be a previously stored confidence value or a confidence value that is updated based on a user event.

The determination unit 603 may determine whether to execute the application based on the comparison result of the comparison unit 602. For example, if the current confidence value exceeds the reference value of the application, execution of the corresponding application may be accepted. As another example, if the current confidence value is below the reference value of the application, execution of the corresponding application may be denied or an additional authentication process may be demanded.

The additional authentication process may be implemented in varied degrees based on the difference between the confidence value and the reference value. For example, a simple authentication, such as drawing a line or touching the screen twice, or a complicated authentication, such as inputting a password or biometric authentication may be used based on the difference between the confidence value and the reference value.

The additional authentication process may be implemented in varied types based on the difference between the confidence value and the reference value. For example, the larger the difference, the higher the level of the additional authentication may be requested.

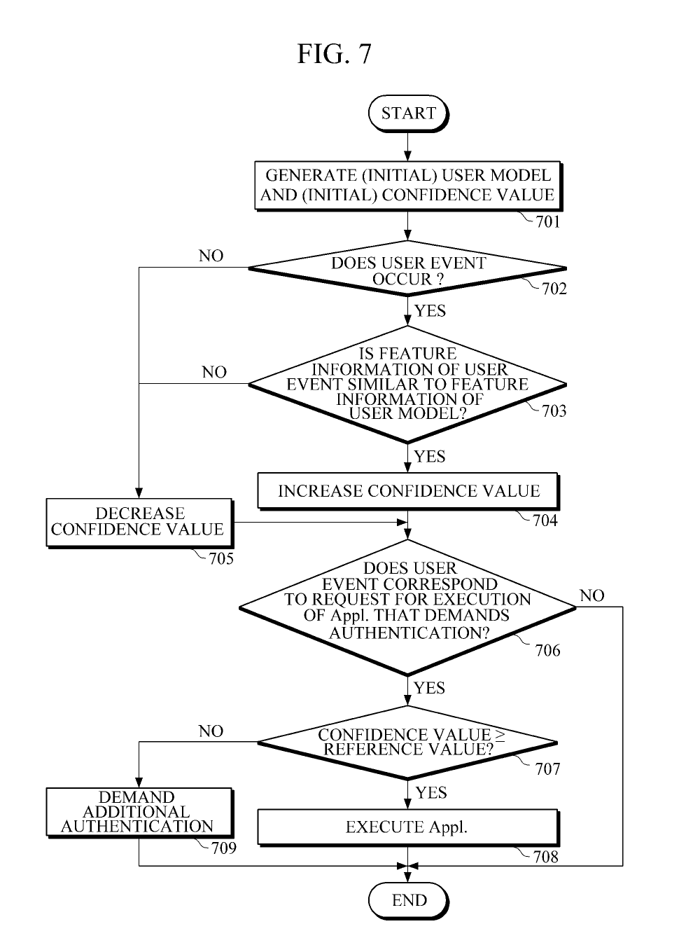

FIG. 7 illustrates an example of a method for user identification.

Referring to FIGS. 1 and 7, the apparatus 100 for user identification generates a user model and a confidence value (701)

For an example, the apparatus 100 may generate an initial user model by collecting a terminal manipulation pattern through a tutorial mode during the first execution of a newly purchased terminal. As another example, the apparatus 100 may set a predetermined user model that is applicable to all users in common, as an initial user model. The user model may be updated as the user uses the terminal such that a manipulation pattern of the user is applied to the user model. In addition, the initial confidence value may be set to a predetermined level of between 0% and 50%.

After the user model and the confidence value are generated, the apparatus 100 for user identification determines whether a user event occurs (702). The user event includes events that occur when a user manipulates the terminal while using the terminal.

If a user event occurs, the apparatus 100 for user identification determines whether feature information of the user event is similar to feature information of the user model (703). Whether the two pieces of feature information are similar to each other may be determined by calculating the similarity between the feature information of the user event and the feature information of the user model based on the comparison function and determining whether the calculated similarity exceeds a threshold value.

If the feature information of the user event is similar to the feature information of the user model, the apparatus 100 for user identification increases the generated confidence value (704).

Conversely, if the feature information of the user event is not similar to the feature information of the user model or a user event does not occur, the apparatus 100 for user identification decreases the generated confidence value (705).

The above sequence may be performed each time a user event occurs. Accordingly, each time a user event occurs, the confidence value may be updated through processes 704 or 705.

The apparatus 100 for user identification determines whether the corresponding event is a user event that requests execution of an application that requests an authentication (706).

If the corresponding user event is a user event that requests execution of an application requesting an authentication, the apparatus 100 for user identification compares the current confidence value with the reference value of the application (707).

If the current confidence value exceeds the reference value of the application, the apparatus 100 for user identification accepts the request for execution and the application is executed (708). If the current confidence value is below the reference value of the application, the apparatus 100 for user identification denies the request for execution, and performs an additional authentication process (709). In 709, the denying of the request for execution and the additional authentication are not mandatory processes. For example, the execution may be denied and no additional authentication may be performed. Alternatively, an additional authentication may be demanded in a state in which the determination about execution of the application is suspended.

According to the above described apparatus and method for user identification, the terminal may determine whether to execute an application or perform an additional authentication process based on each situation while statistically and continually monitoring whether a current user of the terminal is a user that has permission to use the terminal, thereby enhancing user's convenience in use of the terminal and improving the security of the terminal.

Program instructions to perform a method described herein, or one or more operations thereof, may be recorded, stored, or fixed in one or more computer-readable storage media. The program instructions may be implemented by a computer. For example, the computer may cause a processor to execute the program instructions. The media may include, alone or in combination with the program instructions, data files, data structures, and the like. Examples of computer-readable storage media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include machine code, such as produced by a compiler, and files containing higher level code that may be executed by the computer using an interpreter. The program instructions, that is, software, may be distributed over network coupled computer systems so that the software is stored and executed in a distributed fashion. For example, the software and data may be stored by one or more computer readable storage mediums. Also, functional programs, codes, and code segments for accomplishing the example embodiments disclosed herein can be easily construed by programmers skilled in the art to which the embodiments pertain based on and using the flow diagrams and block diagrams of the figures and their corresponding descriptions as provided herein. Also, the described unit to perform an operation or a method may be hardware, software, or some combination of hardware and software. For example, the unit may be a software package running on a computer or the computer on which that software is running.

As a non-exhaustive illustration only, a terminal/device/unit described herein may refer to mobile devices such as a cellular phone, a personal digital assistant (PDA), a digital camera, a portable game console, and an MP3 player, a portable/personal multimedia player (PMP), a handheld e-book, a portable lab-top PC, a global positioning system (GPS) navigation, and devices such as a desktop PC, a high definition television (HDTV), an optical disc player, a setup box, and the like capable of wireless communication or network communication consistent with that disclosed herein.

A computing system or a computer may include a microprocessor that is electrically connected with a bus, a user interface, and a memory controller. It may further include a flash memory device. The flash memory device may store N-bit data via the memory controller. The N-bit data is processed or will be processed by the microprocessor and N may be 1 or an integer greater than 1. Where the computing system or computer is a mobile apparatus, a battery may be additionally provided to supply operation voltage of the computing system or computer. It will be apparent to those of ordinary skill in the art that the computing system or computer may further include an application chipset, a camera image processor (CIS), a mobile Dynamic Random Access Memory (DRAM), and the like. The memory controller and the flash memory device may constitute a solid state drive/disk (SSD) that uses a non-volatile memory to store data.

A number of examples have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. An apparatus for statistical user identification, the apparatus comprising:
an update unit configured to update a confidence value that statistically represents whether a user is identified as being a user that has permission to use a terminal, based on a user event that occurs when the user manipulates the terminal; and
a statistical authentication unit configured to, in response to a user requesting execution of an application that requests authentication, determine whether to execute the requested application by comparing the confidence value with a reference value that is defined for the requested application.

2. The apparatus of claim 1, further comprising a storage unit configured to store the confidence value, a user model that is generated based on feature information about a manipulation pattern that is obtained when the user manipulates the terminal, and a reference value defined for each application.

3. The apparatus of claim 2, wherein the update unit updates the confidence value by increasing or decreasing the confidence value based on the comparison between the user event and the user model.

4. The apparatus of claim 2, wherein the update unit decreases the confidence value if a user event is not detected within a predetermined period of time.

5. The apparatus of claim 2, wherein the update unit applies feature information of a user event that occurs after the updated confidence value exceeds a predetermined threshold value, to the user model.

6. The apparatus of claim 1, wherein the statistical authentication unit accepts the execution of the application, if the confidence value exceeds the reference value.

7. The apparatus of claim 1, wherein the statistical authentication unit denies the execution of the application, if the confidence value is below the reference value.

8. The apparatus of claim 1, wherein the statistical authentication unit demands additional authentication from the user, if the confidence value is below the reference value.

9. The apparatus of claim 8, wherein the statistical authentication unit calculates a difference between the confidence value and the reference value, if the confidence value is below the reference value, and demands additional authentications from the user based on the calculated difference.

10. A method of statistical user identification, the method comprising:
updating a confidence value that statistically represents whether a user is identified as being a user that has permission to use a terminal, based on a user event that occurs when the user manipulates the terminal; and
upon occurrence of a user event requesting execution of an application that requests authentication, determining whether to execute the requested application by comparing the confidence value with a reference value that is defined for the requested application.

11. The method of claim 10, wherein the updating comprises updating the confidence value by increasing or decreasing the confidence value based on a comparison between the user event and the user model.

12. The method of claim 10, wherein the updating comprises decreasing the confidence value, if a user event is not detected within a predetermined period of time.

13. The method of claim 10, further comprising applying feature information of a user event that occurs after the updated confidence value exceeds a predetermined threshold value, to the user model.

14. The method of claim 10, wherein the determining of execution of the application comprises executing the application, if the confidence value exceeds the reference value.

15. The method of claim 10, wherein the determining of execution of the application comprises not executing the application, if the confidence value is below the reference value.

16. The method of claim 10, wherein the determining of execution of the application comprises requesting an additional authentication of the user, if the confidence value is below the reference value.

17. A method for statistical user identification, the method comprising:
detecting a user event that occurs when a user manipulates a terminal;
comparing feature information of the detected user event with feature event of a user model and updating a confidence value that statistically represents whether a user has permission to use the terminal, based on a comparison result of the feature information;
determining whether the detected user event is a user event requesting execution of an application which is executable in the terminal and which requests authentication; and
determining whether to execute the application by comparing the updated confidence value with a reference value that is a previously defined for each application, if the detected user event is the user event requesting execution of the application.

18. The method of claim 17, further comprising:
generating an initial user model based on feature information about a manipulation pattern that is obtained when the user manipulates the terminal; and
generating an initial confidence value that statistically represents whether a user has permission to use the terminal.

19. A terminal for statistical identification of a user that manipulates the terminal, the terminal comprising:
a storage unit configured to store a confidence value that statistically represents whether the user has permission to use a respective application; and
a statistical authentication unit configured to determine whether the user has permission to execute a requested application by comparing the user's confidence value with a reference value that is defined for the requested application.

20. The terminal of claim 19, wherein the user's confidence value is N, a first application requested by the user has a reference value that is greater than N, and the statistical authentication unit determines to deny execution of the application based on a comparison of the user's confidence value and the reference value.

21. The terminal of claim 20, wherein a second application requested by the user has a reference value that is less than N, and the statistical authentication unit determines to execute the application based on a comparison of the user's confidence value and the reference value.

22. The terminal of claim 19, wherein the confidence value is a number between 0% and 100%, 0% represents the minimum confidence value the terminal can have for the user, and 100% represents the maximum confidence value that the terminal can have for the user.

23. The terminal of claim 19, further comprising:
one or more sensors configured to sense user manipulation of the terminal; and
an update unit configured to update the confidence value of the user based on the sensed user's manipulation of the terminal.

24. The terminal of claim 23, wherein the one or more sensors sense at least one of pressure applied by the user to a touch screen of the terminal and speed at which the user inputs characters on the touch screen of the terminal, and the update unit updates the confidence value based on the sensed data.
